(19) United States
(12) Patent Application Publication
(10) Pub. No.: US 2006/0158587 A1
(43) Pub. Date: Jul. 20, 2006

(54) Transflective liquid crystal display

(75) Inventors: Chih-Ming Chang, Jhongli City (TW); Ching-Yu Tsai, Hsinchu City (TW); Ching-Huan Lin, Hsin Ying City (TW); Kuo-Yu Huang, Baoshan Township (TW); Yi-Pai Huang, Chiayi City (TW); Yung-Shun Yang, Magong City (TW); Han-Ping Shieh, Hsinchu City (TW); Po-Lun Chen, Chiayi City (TW)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 11/039,339

(22) Filed: Jan. 20, 2005

(51) Int. Cl. G02F 1/1335

(52) U.S. Cl. 349/114

(57) ABSTRACT

A light channeling layer disposed adjacent to the bottom substrate of a transflective display to enhance the back-lighting efficiency. The transflective display has a transmissive area and a reflective area and the transmissive area has a transmission electrode. The light channeling layer comprises a plurality of light conduits, each of which is disposed behind a transmission electrode. The light conduit has a first aperture and a second aperture greater than the first aperture and the first aperture is positioned adjacent to the transmission electrode and a second aperture adjacent to the back substrate, so that light from a back-light source that enters into the light conduct through the second aperture is channeled to the transmission electrode through the first aperture.

### FIELD OF THE INVENTION

The present invention relates generally to a liquid crystal display panel and, more particularly, to a transflective-type liquid crystal display panel.

### BACKGROUND OF THE INVENTION

Due to the characteristics of thin profile and low power consumption, liquid crystal displays (LCDs) are widely used in electronic products, such as portable personal computers, digital cameras, projectors, and the like. Generally, LCD panels are classified into transmissive, reflective, and transflective types. A transmissive LCD panel uses a back-light module as its light source. A reflective LCD panel uses ambient light as its light source. A transflective LCD panel makes use of both the back-light source and ambient light.

As known in the art, a transflective LCD panel has a two-dimensional array of pixels. As shown in FIG. 1, the transflective LCD panel 1 has a plurality of pixels 10. The LCD panel 1 can be a color LCD panel or a black-and-white (B/W) LCD panel. In a transflective color LCD panel, each of the pixels 10 comprises a plurality of color sub-pixels 12, usually in three primary colors of red (R), green (G) and blue (B) to provide RGB color components in the display, as shown in FIG. 2. These RGB color components can be achieved by using respective color filters. Each color sub-pixel is divided into a transmissive area (TA) and a reflective area (RA). The pixel comprises gate lines 31, 32, data lines 21-24 to control the brightness of each color sub-pixels.

In a transflective B/W LCD panel, each pixel 10 is also divided into a transmissive area and a reflective area. However, no color filters are needed and there are data gate lines in each pixel.

A color LCD panel typically comprises an upper substrate 110, a lower substrate 210, and a liquid crystal layer 160. Each pixel 10 or sub-pixel 12 has an upper electrode layer 150 disposed on the upper substrate 110 and a lower electrode layer disposed on the lower substrate 210, as shown in FIGS. 3a and 3b. The lower electrode layer comprises a reflection electrode 250 (reflector) in the reflective area, and a transmission electrode 254 in the transmissive area. A color sub-pixel also has a color filter (not shown) on the upper substrate. FIG. 3a is a schematic representation of a single-gap transflective display and FIG. 3b is a schematic representation of a dual-gap display. In a single-gap transflective display, the thickness of the liquid crystal layer is substantially uniform throughout the pixel area. In a dual-gap display, the thickness of the liquid crystal layer in the reflective area is substantially half of that in the transmissive area.

As can be seen in FIGS. 3a and 3b, a back-light source 260 provides illumination to the transflective LCD panel, but only part of the light from the back-light source is used in the transmissive area. Part of the light encountered in the reflective area is wasted. Thus, the use of back-light source is not efficient.

### SUMMARY OF THE INVENTION

The present invention provides a method and a light channeling layer for improving the back-lighting efficiency in a transflective liquid crystal display. The light channeling layer comprises a plurality of light conduits, each light conduit located between the transmission electrode in a pixel and the lower substrate, wherein the light conduit has an upper aperture adjacent the transmissive electrode and a lower aperture adjacent the lower substrate, with the upper aperture covering substantially the entire transmissive electrode and the lower aperture larger than the upper aperture, so that more light can be directed to the transmission electrode through the lower aperture.

Thus, the first aspect of the present invention provides a method for improving back-lighting efficiency in a transflective liquid crystal display having a first side and a second side, the liquid crystal display having a plurality of pixels, at least some of the pixels having a transmissive area and a reflective area, wherein the transmissive area has a transmission electrode having an electrode area for allowing light from a back-light source located near the second side of the display to enter through the electrode area to a liquid crystal layer then to the first side of the display, and wherein the reflective area has a reflector adjacent to the transmission electrode for allowing light entering the first side of the display through the liquid crystal layer to reflect back to the first side of the display. The method comprises:

positioning a light conduit between the transmission electrode and the back-light source, the light conduit having a first aperture adjacent to the electrode area of the transmission electrode and a second aperture adjacent to the back-light source, the second aperture larger than the first aperture; and

channeling the light from the back-light source entering the second aperture of the light conduit toward the transmission area through the first aperture.

According to the present invention, the light conduit has a surrounding surface between the first aperture and the second aperture, and part of the light entering the second aperture of the light conduit encounters the surrounding surface, said method further comprising:

enhancing reflectivity of the surface so as to increase reflection amount of the encountering part of the light toward the first aperture.

According to the present invention, the surrounding surface is coated with a reflective metal layer for enhancing the reflectivity.

According to the present invention, first aperture is substantially equal to the electrode area of the transmission area.

The second aspect of the present invention provides a transflective liquid crystal display having a first side and an opposing second side. The display comprises:

a first substrate adjacent to the first side;

a second substrate adjacent to the second side;

a substantially transparent electrode disposed between the first substrate and the second substrate;

a liquid crystal layer disposed between the transparent electrode and the second substrate, the liquid crystal layer covering a plurality of pixels, at least some of the pixels having a pixel area, the pixel area having a transmissive area and a reflective area, wherein the transmissive area has a transmission electrode having an electrode area for allowing light from a back-light source located near the second side of the display to enter through the electrode area to the liquid crystal layer and then to the first side of the display, and wherein the reflective area has a reflector adjacent to the transmission electrode for allowing light entering the first side of the display through the liquid crystal layer to reflect back to the first side of the display; and

a light channeling layer having a plurality of light conduits, each light conduit positioned between the transmission electrode and the second substrate, wherein the light conduit has a first aperture adjacent to the electrode area of the transmission electrode and a second aperture adjacent to the back-light source, so as to allow light from the back-light source entering the second aperture of the light conduit to pass through the first aperture to the electrode area, wherein the second aperture is larger than the first aperture

According to the present invention, the light conduit has a surrounding surface between the first aperture and the second aperture, and the surrounding surface has a reflective coating for reflecting part of the light entering the second aperture and encountering the surround surface toward the first aperture.

According to the present invention, a part of the second aperture is positioned between the reflector and the second substrate.

According to the present invention, the electrode area of the transmission electrode is also positioned adjacent to a reflector of an adjacent pixel, and wherein a further part of the second aperture is also positioned between the reflector of the adjacent pixel and the second substrate.

According to the present invention, the light conduit is made of a substantially transparent material.

According to the present invention, the first aperture is substantially equal to the electrode area of the transmission electrode.

Alternatively, the electrode area of the transmission electrode comprises a plurality of sub-areas, and the first aperture is substantially equal to the sub-area.

Alternatively, the electrode area of the transmission electrode of one pixel is located adjacent to the electrode area of the transmission electrode of at least one adjacent pixel, and the light conduit is positioned such that the first aperture covers substantially the electrode area of said one pixel and the electrode area of said at least one adjacent pixel.

The third aspect of the present invention provides a method of producing a light channeling layer for use in a transflective liquid crystal display having a first side and an opposing second side, the display comprising:

a first substrate adjacent to the first side, the first substrate having a first surface facing the first side and a second surface opposing the first surface;

a second substrate adjacent to the second side, the second substrate having a first surface and an opposing second surface facing the second side;

a substantially transparent electrode disposed between the second surface of the first substrate and the first side of the second substrate; and

a liquid crystal layer disposed between the transparent electrode and the first surface of the second substrate, the layer covering a plurality of pixels, at least some of the pixels having a pixel area, the pixel area having a transmissive area and a reflective area, wherein the transmissive area has a transmission electrode having an electrode area for allowing light from a back-light source located near the second surface of the second substrate to enter through the electrode area to the liquid crystal layer and then to the first side of the display, and wherein the reflective area has a reflector adjacent to the transmission electrode for allowing light entering the first side of the display through the liquid crystal layer to reflect back to the first side of the display; wherein the light channeling layer having a plurality of light conduits, each conduit positioned between the transmission electrode and the first surface of the second substrate, wherein the light conduit has a first aperture adjacent to the electrode area of the transmission electrode and a second aperture adjacent to the back-light source, so as to allow light from the back-light source entering the second aperture of the light conduit to pass through the first aperture to the electrode area, wherein the second aperture is larger than the first aperture. The method comprises the steps of:

disposing a first layer of a substantially transparent material on the first surface of the second substrate;

removing part of the first layer such that the remaining part of the first layer comprising a plurality of lumps, each lump having an upper part and a bottom part on the first surface of the second substrate, the bottom part forming the second aperture of a light conduit, the lump having a wall between the upper part and the bottom part, at least part of the wall forming the surround wall of the light conduit;

disposing a second layer of a reflective material on at least part of the remaining part of the first layer; and

removing part of the reflective material so as to expose the upper part of each lump such that the exposed upper part of the lump forms the first aperture of light conduit.

According to the present invention, the method further comprises the step of:

disposing the third layer of a filler material to fill the space between the lumps.

According to the present invention, the method further comprises the step of:

disposing, before the removing step, a third layer of a filler material on the second layer to form a combined layer including the remaining part of the first layer, so that the removing step removes part of the reflective material as a part of the combined layer so as to expose the upper part of each lump such that the exposed upper part of the lump forms the first aperture of the light conduit.

According to the present invention, the method further comprises the step of

removing part of the second layer prior to disposing the third layer so as to allow part of third layer to be disposed on the first surface of second substrate surrounding the bottom part of the lump.

The present invention will become apparent upon reading the description taken in conjunction with FIGS. 4a to 7e.

### BRIEF DESCRIPTION OF THE DRAWINGS

FIG. 1 is a schematic representation showing the pixel structure of a typical LCD panel.

FIG. 2 is a plan view showing the pixel structure of a conventional transflective color LCD panel.

FIG. 3a is a cross sectional view showing the transmissive area and the reflective area in a pixel or color sub-pixel in a single-gap transflective LCD panel.

FIG. 3b is a cross sectional view showing the transmissive area and the reflective area in a pixel or color sub-pixel in a dual-gap transflective LCD panel.

FIG. 4a is a schematic representation of a cross sectional view showing the transmissive area and the reflective area in a pixel in a single-gap transflective LCD panel, according to the present invention.

FIG. 4b is a schematic representation of a cross sectional view showing the transmissive area and the reflective area in a pixel in a dual-gap transflective LCD panel, according to the present invention.

FIG. 5 is a schematic representation showing the light channeling layer in a transflective LCD panel, according to the present invention.

FIG. 6a is a schematic representation showing the lower electrode arrangement and a light conduit in a pixel of a transflective LCD panel, according to one embodiment of the present invention.

FIG. 6b is a schematic representation showing the lower electrode arrangement and the light conduit in a pixel of a transflective LCD panel, according to another embodiment of the present invention.

FIG. 6c is a schematic representation showing the lower electrode arrangement and the light conduit in a pixel of a transflective LCD panel, wherein each pixel has two transmissive electrodes, according to another embodiment of the present invention.

FIG. 6d is a schematic representation showing the arrangement of the light conduits in adjacent pixels of a transflective LCD panel, according to another embodiment of the present invention.

FIG. 6e is a schematic representation showing the arrangement of the light conduits in adjacent pixels of a transflective LCD panel, according to another embodiment of the present invention.

FIGS. 7a-7e illustrate the process of fabricating the light channeling layer, according to the present invention, in which:

FIG. 7a shows the deposit of a layer of a transparent material on the lower substrate;

FIG. 7b shows the partial removal of the transparent material layer for forming a plurality of bumps;

FIG. 7c shows the coating of the bumps with a layer of reflective material;

FIG. 7d shows the deposit of a filler material over the reflective layer; and

FIG. 7e shows the etching of the combined layer for forming the light channeling layer, according to the present invention.

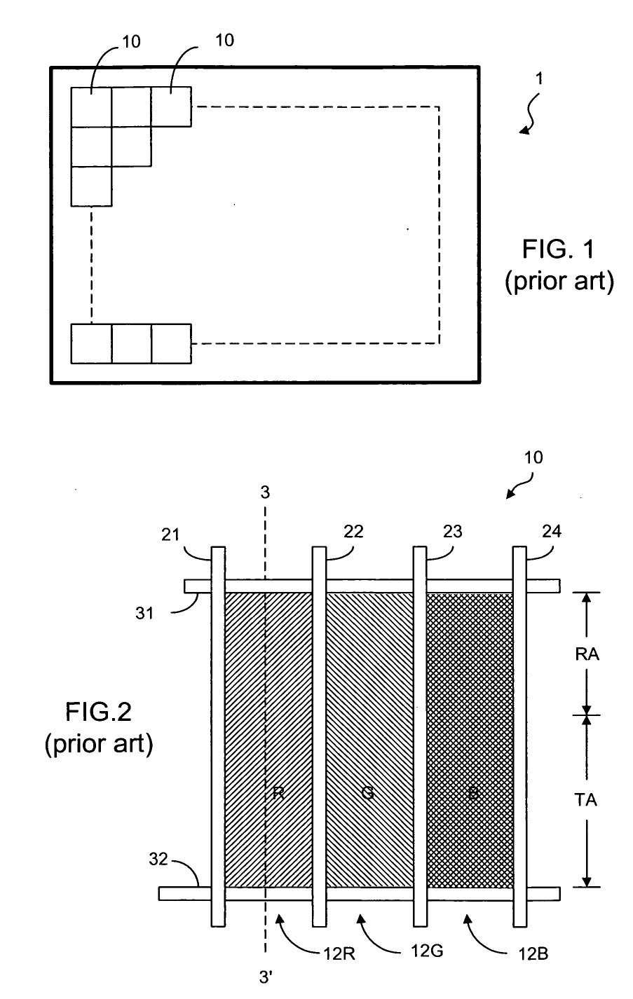

### DETAILED DESCRIPTION OF THE INVENTION

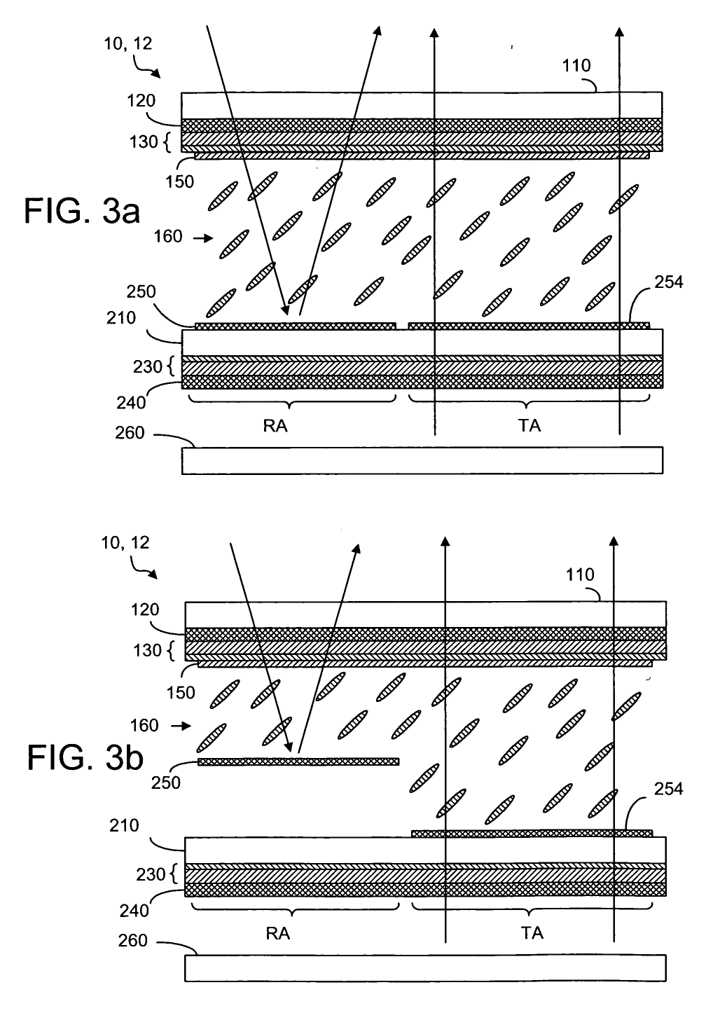

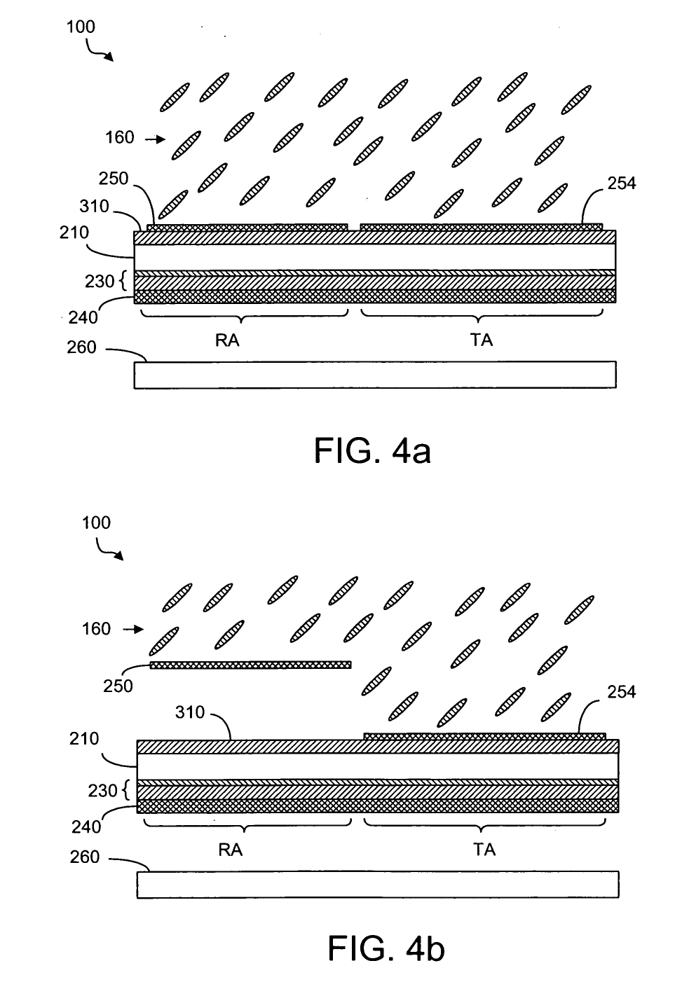

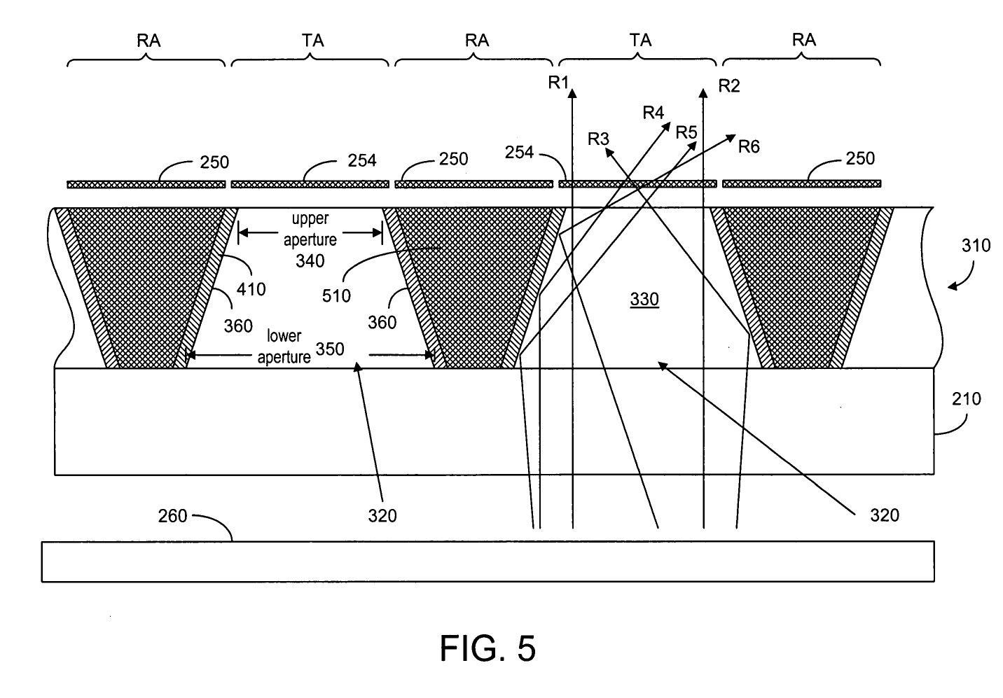

The present invention is applicable to transflective color LCD panels as well as transflective black-and-white LCD panels. As shown in FIGS. 2-3b, a pixel 10 in a transflective color LCD panel is divided into three color sub-pixels 12R, 12G and 12B, and each sub-pixel has a transmission electrode 254 in its transmissive area (TA) and a reflection electrode 250 in its reflective area (RA). Similarly, a pixel 10 in a transflective LCD panel has a transmission electrode in its transmissive area and a reflection electrode in its reflective area. FIGS. 4a -6e show the transmission electrode 254 and the reflection electrode 250 in a pixel area 100 of a pixel in a B/W LCD panel, or a color sub-pixel in a color LCD panel.

The present invention provides a light channeling layer 310 between the back-light source 260 and the lower electrode layer (250, 254) to increase the amount of back-light transmitted through the transmission electrode 254. It should be noted that a transmission electrode in a pixel or sub-pixel is used, together with the upper electrode 150 (see FIGS. 3a and 3b), to provide an electric field to the liquid crystal layer 160 in the transmissive area. A small portion of the transmission electrode may be used for electrical connections to other electronic components disposed on the lower substrate. This portion of the transmission electrode may not be used for transmitting light from the back-light source 260, but most part of the transmission electrode receives light from the back-light source and allows it to transmit therethrough. In this disclosure, the transmission electrode 254 refers to the light reception portion of the lower electrode in the transmissive area.

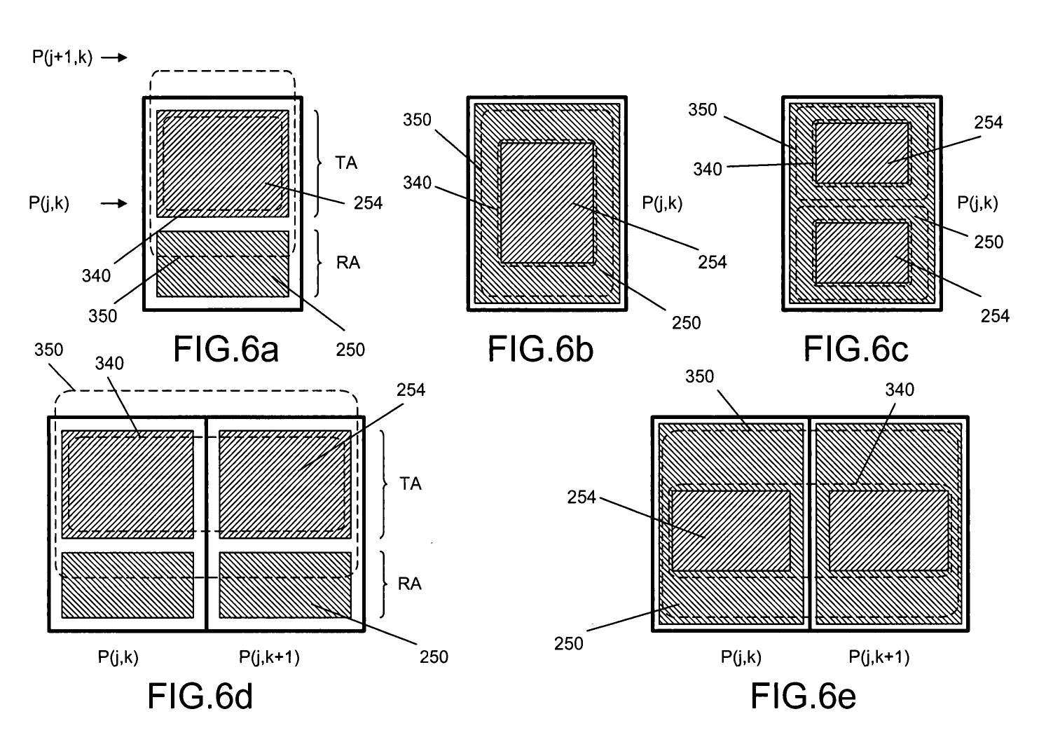

As shown in FIG. 5, the light channeling layer 310 is disposed on the lower substrate 210. As shown, the light channeling layer 310 has a plurality of light conduits 320 located below the transmission electrodes 254. Each light conduit 320 has a channel 330 surrounded by a wall 360. The channel 330 has an upper aperture 340 and a lower aperture 350. The upper aperture 340 is substantially equal to the light reception area of the transmission electrode 254, but it can be slightly smaller or larger. The lower aperture 350 is larger than the upper aperture 340 so as to admit more light from the light source 260 than the amount of light that would be received by the transmission electrode 254 without the light conduit 320. Advantageously, the wall 360 is coated with a highly reflective material 410 so that the wall 360 efficiently reflects light encountered by the wall 360 toward the upper aperture 340. As shown in FIG. 5, light rays R1, R2 pass through the channel 330 by transmission only, but light rays R3-R6 pass through the channel 330 also by reflection via the wall 360. As such, the amount of light from the back-light source 260 through the transmission electrode 250 is increased by the light channel layer 310.

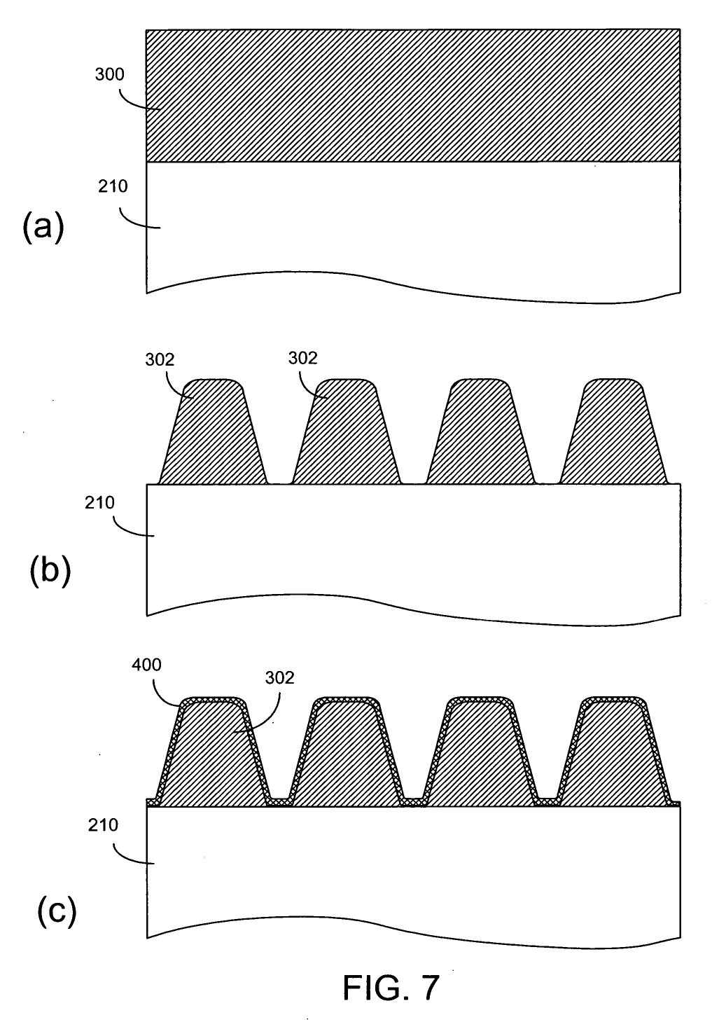

The placement of the light conduits 320 relative to the pixel area 100 is dependent upon the arrangement of the lower electrodes 250, 254. For example, if the transmission electrode 254 and the reflection electrode 250 are separately located on different sides of the pixel area P(j, k), as shown in FIG. 6a, then the part of the light conduit 320 is extended to an adjacent pixel area P(j+1, k). The light conduit is schematically represented by the upper aperture 340 and the lower aperture 350. If the transmission electrode 254 is surrounded by the reflection electrode 250 (they are electrically disconnected from each other), then it is possible that the lower aperture 350 is also located within the pixel area, as shown in FIG. 6b. It is also possible that two or more transmission electrodes 254 are used in a pixel area, as shown in FIG. 6c. In that case, more than one light conduit is used to enhance the back-light efficiency of the LCD panel. It is also possible that one light conduit is used to channel light to two transmission electrodes 254 in adjacent pixel areas P(j, k), P(j, k+1). A similar arrangement is shown in FIG. 6e.

Advantageously, the channel 330 of the light conduit 320 is filled with a transparent material so that the transmission electrode 254 can be disposed directly on top of the light channeling layer 310. Also, the space between adjacent light conduits 320 is filled with a filler material 510.

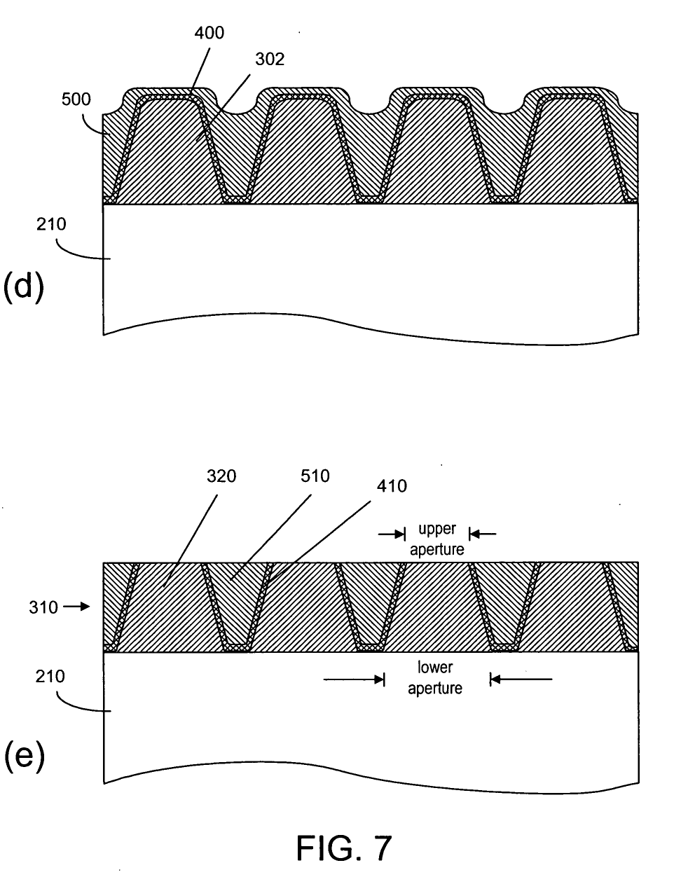

FIGS. 7a-7e illustrate the process of fabricating the light channeling layer 310, according to the present invention. FIG. 7a shows a layer of a substantially transparent material 300 being deposited on the lower substrate 210. The layer 300 can be partially etched away so that the remaining part of the layer 300 comprises a plurality of bumps 302, as shown in FIG. 7b. The layer 300 can be made of a photoresist, for example. The remaining part of the layer 300 is then coated with a layer of reflective material 400, such as aluminum or another suitable metal, as shown in FIG. 7c. A layer of filler material 500 is then coated on top of the layer 400, as shown in FIG. 7d. Finally, the top of the combined layers are removed to expose the upper aperture of the light conduits in the light channeling layer 310. In the above-described fabrication process, it is possible to remove only the top portion of the reflective layer 400 after it has been deposited on the bumps 302 as shown in FIG. 7c. Subsequently a layer of transparent filler material 500 is used to fill the space between the bumps 302. Although some of the transparent filler material 500 may be deposited on the top of the bumps 302, a thin coating of the transparent filler material 500 does not significantly change the optical property of the light conduit 320. As such, the final step to remove the top part of the layers, as shown in FIG. 7d, would not be necessary.

In sum, the present invention uses a light channeling layer having a plurality of light conduits to increase the amount of light transmitted through the transmission electrode in the transmissive area of a pixel or a sub-pixel in a transflective LCD panel. The transflective LCD panel can be color or black-and-white and the pixel structure can be of a single-gap type or dual-gap type. It is possible that each pixel area has one, two or more light conduits to bring more light to the pixel. It is also possible that two or more pixel areas share one light conduit. Furthermore, when two or more transmission electrodes are used in one pixel, these transmission electrodes can be arranged in a certain way to minimize Moire effect. The upper and lower apertures of the light conduit can be similar or different, and the shape of the apertures can be rectangular, square, circular, elliptical or any other shape depending largely on the shape of the transmission electrode and the arrangement of the lower electrodes.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for improving back-lighting efficiency in a transflective liquid crystal display having a first side and a second side, the liquid crystal display having a plurality of pixels, at least some of the pixels having a transmissive area and a reflective area, wherein the transmissive area has a transmission electrode having an electrode area for allowing light from a back-light source located near the second side of the display to enter through the electrode area to a liquid crystal layer then to the first side of the display, and wherein the reflective area has a reflector adjacent to the transmission electrode for allowing light entering the first side of the display through the liquid crystal layer to reflect back to the first side of the display, said method comprising:
positioning a light conduit between the transmission electrode and the back-light source, the light conduit having a first aperture adjacent to the electrode area of the transmission electrode and a second aperture adjacent to the back-light source, the second aperture larger than the first aperture; and
channeling the light from the back-light source entering the second aperture of the light conduit toward the transmission area through the first aperture.

2. The method of claim 1, wherein the light conduit has a surrounding surface between the first aperture and the second aperture, and wherein part of the light entering the second aperture of the light conduit encounters the surrounding surface, said method further comprising:
enhancing reflectivity of the surface so as to increase reflection amount of the encountering part of the light toward the first aperture.

3. The method of claim 2, wherein the surrounding surface is coated with a reflective metal layer for enhancing the reflectivity.

4. The method of claim 1, wherein the first aperture is substantially equal to the electrode area of the transmission area.

5. A transflective liquid crystal display having a first side and an opposing second side, the display comprising:
a first substrate adjacent to the first side;
a second substrate adjacent to the second side;
a substantially transparent electrode disposed between the first substrate and the second substrate;
a liquid crystal layer disposed between the transparent electrode and the second substrate, the liquid crystal layer covering a plurality of pixels, at least some of the pixels having a pixel area, the pixel area having a transmissive area and a reflective area, wherein the transmissive area has a transmission electrode having an electrode area for allowing light from a back-light source located near the second side of the display to enter through the electrode area to the liquid crystal layer and then to the first side of the display, and wherein the reflective area has a reflector adjacent to the transmission electrode for allowing light entering the first side of the display through the liquid crystal layer to reflect back to the first side of the display; and
a light channeling layer having a plurality of light conduits, each light conduit positioned between the transmission electrode and the second substrate, wherein the light conduit has a first aperture adjacent to the electrode area of the transmission electrode and a second aperture adjacent to the back-light source, so as to allow light from the back-light source entering the second aperture of the light conduit to pass through the first aperture to the electrode area, wherein the second aperture is larger than the first aperture

6. The transflective display of claim 5, wherein the light conduit has a surrounding surface between the first aperture and the second aperture, and the surrounding surface has a reflective coating for reflecting part of the light entering the second aperture and encountering the surround surface toward the first aperture.

7. The transflective display of claim 5, wherein a part of the second aperture is positioned between the reflector and the second substrate.

8. The transflective display of claim 7, wherein the electrode area of the transmission electrode is also positioned adjacent to a reflector of an adjacent pixel, and wherein a further part of the second aperture is also positioned between the reflector of the adjacent pixel and the second substrate.

9. The transflective display of claim 5, wherein the light conduit is made of a substantially transparent material.

10. The transflective display of claim 5, wherein the first aperture is substantially equal to the electrode area of the transmission electrode.

11. The transflective display of claim 5, wherein the electrode area of the transmission electrode comprises a plurality of sub-areas, and wherein the first aperture is substantially equal to the sub-area.

12. The transflective display of claim 5, wherein the electrode area of the transmission electrode of one pixel is located adjacent to the electrode area of the transmission electrode of at least one adjacent pixel, and the light conduit is positioned such that the first aperture covers substantially the electrode area of said one pixel and the electrode area of said at least one adjacent pixel.

13. A method of producing a light channeling layer for use in a transflective liquid crystal display having a first side and an opposing second side, the display comprising:
a first substrate adjacent to the first side, the first substrate having a first surface facing the first side and a second surface opposing the first surface;
a second substrate adjacent to the second side, the second substrate having a first surface and an opposing second surface facing the second side;
a substantially transparent electrode disposed between the second surface of the first substrate and the first side of the second substrate; and
a liquid crystal layer disposed between the transparent electrode and the first surface of the second substrate, the layer covering a plurality of pixels, at least some of the pixels having a pixel area, the pixel area having a transmissive area and a reflective area, wherein the transmissive area has a transmission electrode having an electrode area for allowing light from a back-light source located near the second surface of the second substrate to enter through the electrode area to the liquid crystal layer and then to the first side of the display, and wherein the reflective area has a reflector adjacent to the transmission electrode for allowing light entering the first side of the display through the liquid crystal layer to reflect back to the first side of the display; wherein the light channeling layer having a plurality of light conduits, each conduit positioned between the transmission electrode and the first surface of the second substrate, wherein the light conduit has a first aperture adjacent to the electrode area of the transmission electrode and a second aperture adjacent to the back-light source, so as to allow light from the back-light source entering the second aperture of the light conduit to pass through the first aperture to the electrode area, wherein the second aperture is larger than the first aperture, said method comprising the steps of:
disposing a first layer of a substantially transparent material on the first surface of the second substrate;
removing part of the first layer such that the remaining part of the first layer comprising a plurality of lumps, each lump having an upper part and a bottom part on the first surface of the second substrate, the bottom part forming the second aperture of a light conduit, the lump having a wall between the upper part and the bottom part, at least part of the wall forming the surround wall of the light conduit;
disposing a second layer of a reflective material on at least part of the remaining part of the first layer; and
removing part of the reflective material so as to expose the upper part of each lump such that the exposed upper part of the lump forms the first aperture of light conduit.

14. The method of claim 13, further comprising the step of:
disposing the third layer of a filler material to fill the space between the lumps.

15. The method of claim 13, further comprising the step of:
disposing, before the removing step, a third layer of a filler material on the second layer to form a combined layer including the remaining part of the first layer, so that the removing step removes part of the reflective material as a part of the combined layer so as to expose the upper part of each lump such that the exposed upper part of the lump forms the first aperture of the light conduit.

16. The method of claim 15, further comprising the step of
removing part of the second layer prior to disposing the third layer so as to allow part of third layer to be disposed on the first surface of second substrate surrounding the bottom part of the lump.
